(19) United States
(12) Patent Application Publication
(10) Pub. No.: US 2006/0287108 A1
(43) Pub. Date: Dec. 21, 2006

(54) WAGERING GAME WITH USB NONVOLATILE STORAGE

(76) Inventor: Stephen A. Canterbury, Antioch, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/383,876

(22) Filed: May 17, 2006

Related U.S. Application Data
(60) Provisional application No. 60/681,640, filed on May 17, 2005.

(51) Int. Cl. A63F 13/00

(52) U.S. Cl. 463/43

(57) ABSTRACT

A computerized wagering game system has a gaming module and a USB nonvolatile storage system. The gaming module comprises a processor and gaming code which is operable when executed on the processor to conduct a wagering game on which monetary value can be wagered; and the USB nonvolatile storage system comprises a USB flash memory operable to store data that the wagering game system is operable to read. In various further embodiments, the USB flash storage device is read-only, includes a file authentication capability, or contains software instructions the computerized wagering game system is operable to execute. In another embodiment, the USB flash storage device contains data comprising at least one of operating system data, program data, sound data, video data, and graphic data, or configuration data.

### RELATED APPLICATIONS

This application claims priority under 35 U.S.C. 119(e) from U.S. Provisional Application Ser. No. 60/681,640 filed May 17, 2005, which application is incorporated herein by reference.

### FIELD OF THE INVENTION

The invention relates generally to computerized wagering game machines, and more specifically to computerized wagering game systems having USB-attached nonvolatile storage.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

Traditional mechanical wagering game machines such as slot machines have largely been replaced by computerized electronic wagering game systems, which are also rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized wagering game systems are in many ways the same as mechanical and table game counterparts in that they share many elements. They should be fair, they should provide sufficient feedback to the game player to make the game fun to play, and they should meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon software loaded into the wagering game system to conduct a wagering game. The software is stored in nonvolatile storage such as a hard disk drive, which also contains other data used in presentation of the wagering game such as graphics, video, and sound files.

This information is typically used only after verification that the data has not been altered since being produced, such as by checking a digital signature or verifying a hash result of the stored data. This ensures that the information loaded has not been altered, potentially changing the rules or odds of a wagering game. But, as software is debugged, improved, and replaced with more up-to-date wagering game software, it is desirable to be able to replace the software in a wagering game system with new software.

It is therefore desirable to be able to easily and efficiently update or replace software in a computerized wagering game system.

### SUMMARY

One example embodiment of the invention comprises a computerized wagering game system having a gaming module and a USB nonvolatile storage system. The gaming module comprises a processor and gaming code which is operable when executed on the processor to conduct a wagering game on which monetary value can be wagered; and the USB nonvolatile storage system comprises a USB flash memory operable to store data that the wagering game system is operable to read.

In various further embodiments, the USB flash storage device is read-only, includes a file authentication capability, or contains software instructions the computerized wagering game system is operable to execute. In another embodiment, the USB flash storage device contains data comprising at least one of operating system data, program data, sound data, video data, and graphic data, or configuration data.

### BRIEF DESCRIPTION OF THE FIGURES

FIG. 1 shows a computerized wagering game machine, as may be used to practice some example embodiments of the invention.

FIG. 2 is a block diagram of a computerized wagering game system employing a USB storage device, consistent with some example embodiments of the invention.

FIG. 3 is USB storage device, consistent with some example embodiments of the invention.

FIG. 4 is a flowchart, illustrating a method of practicing an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Various examples of the present invention presented here seek to provide the computerized wagering game system with an easy and efficient way to receive electronic data. One example embodiment of the invention comprises a computerized wagering game system having a gaming module and a USB nonvolatile storage system. The gaming module comprises a processor and gaming code which is operable when executed on the processor to conduct a wagering game on which monetary value can be wagered; and the USB nonvolatile storage system comprises a USB flash memory operable to store data that the wagering game system is operable to read. In various further embodiments, the USB flash storage device is read-only, includes a file authentication capability, or contains software instructions the computerized wagering game system is operable to execute. In another embodiment, the USB flash storage device contains data comprising at least one of operating system data, program data, sound data, video data, and graphic data, or configuration data.

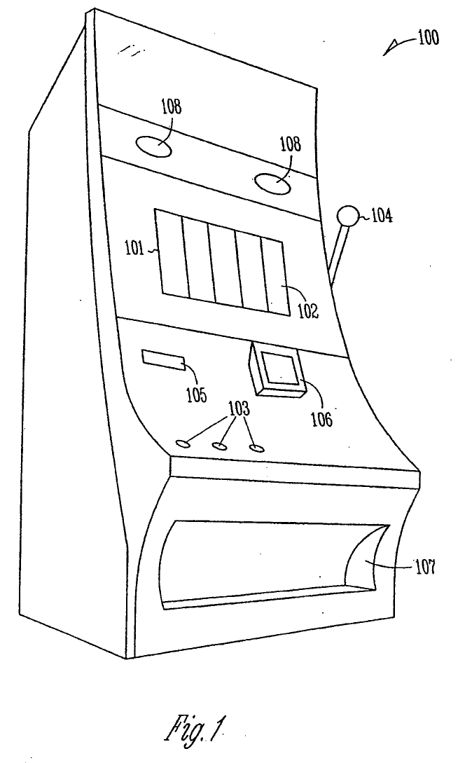

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. Alternate embodiments of the invention will have other game indicators, such as mechanical reels instead of the video graphics reels shown at 102 that comprise a part of a video slot machine wagering game.

A wagering game is implemented using software within the wagering game system, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The wagering game implemented via the loaded software takes various forms in different wagering game machines, including such well-known wagering games as reel slots, video poker, blackjack, craps, roulette, or hold 'em games. The wagering game is played and controlled with inputs such as various buttons 103 or via a touchscreen overlay to video screen 101. In some alternate examples, other devices such as pull arm 104 used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 105 or a secure user identification module interface 106, and winnings are returned via the returned value card or through the coin tray 107. Sound is also provided through speakers 108, typically including audio indicators of game play, such as reel spins, credit bang-ups, and environmental or other sound effects or music to provide entertainment consistent with a theme of the computerized wagering game. The wagering game system takes alternate forms in some embodiments of the invention, such as a portable wireless wagering game device or a user-supplied device operable to present a wagering game conducted on a server. In some further embodiments, the wagering game machine is coupled to a network, and is operable to use its network connection to receive wagering game data, track players and monetary value associated with a player, and to perform other such functions.

The speakers 108 and the display 101 are used in one example embodiment of the invention to provide information related to the wagering game to the game player, along with other information such as graphics or animation designed to entertain. The graphics are accompanied by sounds, such as to indicate a game activity like bang-up of credits, or winning a game event. Other sounds are environmental sounds intended to enhance the theme of the wagering game, such as frogs croaking, fishing reels casting, and boat motors running in a fishing-themed wagering game.

The software instructions, audio files, video files, graphics, and other data used in the wagering game system are examples of data that is stored on a Universal Serial Bus (USB) nonvolatile storage device in some embodiments of the invention. The USB storage device in one example contains flash memory, also known as nonvolatile random access memory, nonvolatile ram, or simply nvram. In some further embodiments, the USB storage device includes authentication capability, such as the ability to verify a digital signature or compute a hash function result

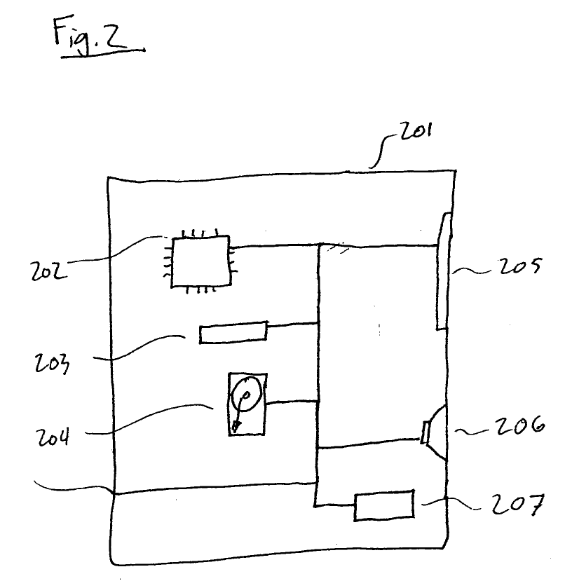

FIG. 2 shows a block diagram of a computerized wagering game system having a USB storage device, consistent with an example embodiment of the present invention. The wagering game system 201 has a processor 202, which is operable to execute software instructions, such as to load and run an operating system and to conduct a computerized wagering game upon which monetary value can be wagered. Program data and other data is stored in memory 203 during operation of the wagering game system, but memory 203 is a type of memory known as volatile memory, and does not retain its contents when the wagering game system is powered off. Hard disk drive 204 or other nonvolatile storage stores wagering game system application data in some embodiments, and in further embodiments also stores other data such as audio data, video data, graphics data, and configuration information. The computerized wagering game system is operable to present information to a game player or other user via a screen such as touchscreen display 205, and through one or more speakers 206. The display and speakers in further embodiments are used to play audio and video files stored in nonvolatile storage, and to present other graphics and sound effects consistent with operation of the wagering game. A USB storage device 207 functions much like the disk drive 204, and is operable to store data such that the wagering game system can retrieve it for use, such as by loading it into memory 203. A network connection 208 couples the computerized wagering game system to a network, which in various embodiments includes a network controller operable to receive status information from the wagering game system, or comprises other wagering game systems coupled as part of a bank of progressive game systems that participate in a chance to win the same progressive jackpot.

In operation, the processor loads program instructions or software from nonvolatile storage such as hard disk drive 204 or the USB storage device 207. The software includes instructions for executing a wagering game upon which monetary value can be wagered. Typically, the software is loaded into memory 203, from which it is executed by the processor 202. In some embodiments, the software is marked with a digital signature, is identified with a hash value, or is otherwise authenticated either before or as a part of executing the stored program instructions. The USB storage device 207 is used in some embodiments in place of hard disk drive 204, and in other embodiments is used to carry new program instructions or other data to the wagering game system which is operable to retrieve the new data from the flash drive and store it on the hard disk drive once it has been authenticated.

Authentication is typically performed using an algorithm from an area of technology referenced by the terms encryption, authentication, or digital signature technology. A few examples are presented here, including symmetric algorithms, public key algorithms, and one-way hash functions. Various embodiments of the invention rely on algorithms such as these being implemented in software on the wagering game system 201, or within hardware such as on the USB storage device 207.

A symmetric algorithm relies on agreement of a secret key before encryption, and the decryption key is either the same as or can be derived from the encryption key. Secrecy of the key or keys is vital to ensuring secrecy of the data in such systems, and the key must be securely distributed to the receivers before decryption. Common symmetric algorithms include DES, 3DES or triple-DES, IDEA, and RC4.

Public key algorithms, or asymmetric algorithms, are designed so that the decryption key is different than and not easily derivable from the encryption key. The term “public key” is used because the encryption key can be made public without compromising the security of data encrypted with the encryption key. Anyone can therefore use the public key to encrypt a message, but only a receiver with the corresponding decryption key can decrypt the encoded data. The encryption key is often called the public key, and the decryption key is often called the private key in such systems. Common public key algorithms include RSA and Diffie-Hellman.

One-way hash functions take an input string and derive a fixed length hash value. The functions are designed so that it is extremely difficult to produce an input string that produces a certain hash value, resulting in a function that is considered one-way. Data can therefore be checked for authenticity by verifying that the hash value resulting from a given one-way hash function is what is expected, making authentication of data relatively certain. Hash functions can be combined with other methods of encryption or addition of secret strings of text in the input string to ensure that only the intended parties can encrypt or verify data using the one-way hash functions. Common examples of one-way hash function encryption include MD4, MD5, and SHA.

Any of the methods described here and any other suitable authentication method may be used in various embodiments of the invention to confirm that the data loaded from the USB storage device 207 or hard disk drive 204 has not been altered since being produced by a game designer or approved by a gaming regulatory authority.

The USB storage device in one embodiment is of sufficient capability that software programs such as the instructions executed to conduct the wagering game are loaded into memory directly from the USB storage device into memory for execution. Additional data such as audio or video data is stored on the USB storage device, on a hard disk drive such as hard disk 204, or on another media such as a compact disc or DVD. In other embodiments, the USB storage device is operable to carry information to be loaded onto another storage device within the wagering game system, such as to be stored on hard disk drive 204 before execution of the software.

Such applications are of particular advantage where data such as configuration of the wagering game system or a software update or change is to be installed on multiple wagering game machines. Because the USB storage device is removable in some embodiments, it can be inserted into a wagering game system to load data into the wagering game system, and removed and installed in another machine once data transfer is complete. In some further embodiments, the USB interface is located inside the locked wagering game machine cabinet to prevent unauthorized tampering or access, while in other embodiments is external to the machine, and uses an authentication protocol to confirm the authenticity of data before loading or executing data from the USB storage device.

In a further embodiment, an external USB port is further usable to receive other data, such as to receive a USB identity module or other USB device belonging to a wagering game player. Such USB devices can be used to store information such as a player identity, player rating, progress a player has made in a particular wagering game, a player's preferences or user settings, media files such as the player's favorite music, or other such data. Because such data will often be written to the player's USB device, it is distinguished in some embodiments from USB storage devices such as 207 that are operable to carry executable instructions for execution on the wagering game machine by authentication data and by write-protecting the USB storage device 207 such that the wagering game machine is not able to store data on the USB storage device 207.

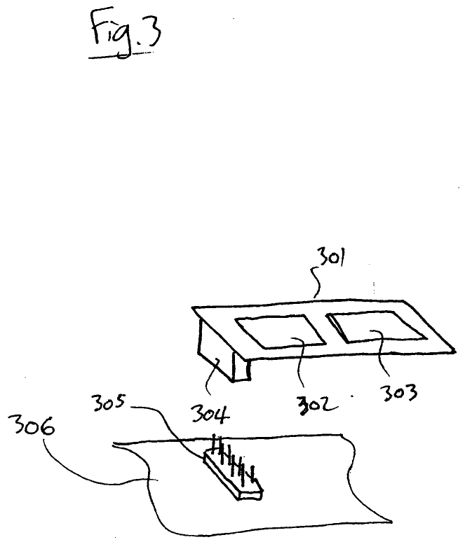

FIG. 3 shows a more detailed view of an example USB storage device, consistent with an example embodiment of the invention. A circuit board 301 has one or more nonvolatile memory integrated circuits 302 and 303 attached thereto, along with other integrated circuits that in various embodiments include a USB interface controller, an authentication processor, or other such circuitry. The circuit board also has a connector 304 operable to mate with a connector 305 coupled to a printed circuit board 306 of the wagering game system. The circuit board 301, electronic components such as memory integrated circuits 302 and 303, and connector 304 make up the USB storage device. The example shown in FIG. 3 is removably attachable to the computerized wagering game system through connectors 304 and 305, enabling this device to be replaced or moved from system to system.

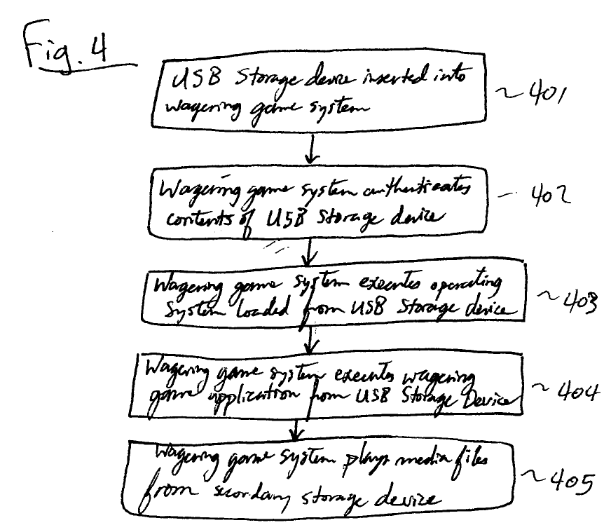

FIG. 4 is a flowchart of a method of practicing one example embodiment of the invention. At 401, a USB storage device is connected to a computerized wagering game system. The computerized wagering game system is powered on and recognized the presence of the device, causing the wagering game system to authenticate the contents of the USB storage device at 402. In some embodiments the authentication is done in software executing on the computerized wagering game system's processor, while in other embodiments the authentication is performed within the USB storage device or via other hardware. At 403, the wagering game system executes an operating system loaded from the USB storage device. The wagering game system proceeds to load and execute program instructions or software for conducting a wagering game at 404, in which the gaming application loaded from the USB storage device into memory and executed.

In some further embodiments, media files such as audio, video, and graphics are loaded from a secondary storage device at 405 that does not contain executable program instructions, such as from a DVD, compact disc, or other such storage device. Because media files are not executed and do not change the play or outcome of the wagering game, media files can in some examples be subject to less stringent authentication or access control than the game code, making distribution on a medium such as a DVD appropriate. Such secondary media systems have the further advantage that only the software stored on a USB storage device or hard disk for execution must be authenticated rather than the software plus a large volume of media files stored on the same volume, greatly reducing the time and processing power needed to authenticate the volume containing the operating system, software, and other executable code upon starting the wagering game system.

The examples presented here illustrate how a USB storage device can be used in a wagering game machine to convey information to the wagering game system. Embodiments shown include using the USB storage device to store program information, to perform authentication, and to convey configuration information or software updates to the wagering game machine. Examples have also included embodiments in which the USB storage device was temporarily installed, such as to convey a configuration, or semi-permanently installed, such as when used to store the operating system or program executed by the wagering game system.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module comprising a processor and gaming code which is operable when executed on the processor to conduct a wagering game on which monetary value can be wagered; and
a nonvolatile USB storage system operable to receive a Universal Serial Bus (USB) flash memory device having data stored in nonvolatile memory thereon, the electronic data comprising software instructions.

2. The computerized wagering game system of claim 1, wherein the USB flash memory device is operated as a read-only device.

3. The computerized wagering game system of claim 1, wherein the nonvolatile storage system is operable to receive the USB flash memory device at a physical location inside a wagering game system cabinet.

4. The computerized wagering game system of claim 1, wherein the gaming module is operable to execute program instructions loaded from the USB flash memory device.

5. The computerized wagering game system of claim 1, wherein the USB flash memory device contains at least one of operating system data, program data, sound data, video data, configuration data, player data, and graphic data.

6. The computerized wagering game system of claim 1, wherein the USB flash memory device is further operable to authenticate data stored thereon.

7. The computerized wagering game system of claim 1, wherein the USB flash memory device is operable to convey configuration information to the wagering game system.

8. A method of operating a wagering game machine, comprising:
conducting a wagering game on which monetary value can be wagered; and
receiving data from a Universal Serial Bus (USB) flash memory device having data stored in nonvolatile memory thereon, the electronic data comprising software instructions.

9. The method of claim 8, wherein the USB flash memory device is operated as a read-only device.

10. The method of claim 8, wherein the nonvolatile storage system is operable to receive the USB flash memory device at a physical location inside a wagering game system cabinet.

11. The method of claim 8, wherein the gaming module is operable to execute program instructions loaded from the USB flash memory device.

12. The method of claim 8, wherein the USB flash memory device contains at least one of operating system data, program data, sound data, video data, configuration data, player data, and graphic data.

13. The method of claim 8, wherein the USB flash memory device is further operable to authenticate data stored thereon.

14. The method of claim 8, wherein the USB flash memory device is operable to convey configuration information to the wagering game system.

15. A machine-readable medium with instructions stored thereon, the instructions when executed operable to cause a computerized system to:
conduct a wagering game on which monetary value can be wagered; and
receive data from a Universal Serial Bus (USB) flash memory device having data stored in nonvolatile memory thereon, the electronic data comprising software instructions.

16. The method of claim 15, wherein the USB flash memory device is operated as a read-only device.

17. The method of claim 15, wherein the nonvolatile storage system is operable to receive the USB flash memory device at a physical location inside a wagering game system cabinet.

18. The method of claim 15, wherein the gaming module is operable to execute program instructions loaded from the USB flash memory device.

19. The method of claim 15, wherein the USB flash memory device contains at least one of operating system data, program data, sound data, video data, and graphic data, configuration data, player data, or configuration data.

20. The method of claim 15, wherein the USB flash memory device is further operable to authenticate data stored thereon.
